(19) United States
(12) Patent Application Publication
(10) Pub. No.: US 2005/0259240 A1
(43) Pub. Date: Nov. 24, 2005

(54) Optical navigation of vehicles

(76) Inventor: David P. Goren, Smithtown, NY (US)

Correspondence Address: BAKER & BOTTS, 30 ROCKEFELLER PLAZA, NEW YORK, NY, 10112, US

(21) Appl. No.: 10/945,082

(22) Filed: Sep. 20, 2004

Related U.S. Application Data
(60) Provisional application No. 60/503,953, filed on Sep. 18, 2003.

(51) Int. Cl. G01P 3/36

(52) U.S. Cl. 356/28

(57) ABSTRACT

Optical motion detectors of the type used in a computer mouse are mounted on the bottom of a vehicle for detecting motion of the vehicle along a surface. Position of the vehicle can thereafter be computed by “dead reckoning.” In a preferred arrangement, optical markings on the surface can be used, or other arrangements can be used, to calibrate the system.

### BACKGROUND OF THE INVENTION

This invention relates to determining the position of vehicles which are traveling over a surface. The term vehicles as used in this specification is intended to encompass vehicles which travel over a surface, such as a floor of a supermarket, outside ground or warehouse, typically on wheels, but which may also travel on skid, air cushions or other supporting mechanisms. It is an object of the invention to provide a system and method for navigation of such vehicles by determining the “dead reckoning” movement of such vehicles over the surface. The vehicles may be, for example shopping carts, forklift trucks, golf cars, automobiles, busses, self-propelled carriers, such as automated mail carriers and the like. The vehicles may either be self-propelled or propelled by a user, as in the case of a shopping cart.

In applications, which involve self-propelled unmanned vehicles, navigation of the vehicles is an important consideration in determining the path that the vehicles travel. In some known prior art technique, stripes or other markings are placed on a floor, and the vehicles are arranged to optically follow such markings.

In the case of non-self-propelled vehicles, such as forklift trucks, shopping carts, and the like, it may be desirable to maintain a record of the location of the vehicle for purposes of assigning the vehicles for new work or for purposes of determining the position of a shopper using a shopping cart, for example to provide the shopper with information concerning specials in or near the location at which the shopping cart is located.

It is therefore an object of the present invention to provide a new and improved system and method for locating vehicles which travel over a surface.

### SUMMARY OF THE INVENTION

In accordance with a first embodiment, the invention there is provided a locating system for vehicles to arrange to move over a surface. The system includes a first optical motion detector for detecting movement of the vehicle in first and second different directions from the vehicle with respect to the surface. There is also provided a second optical motion detector spaced on the vehicle from the first optical motion detector for detecting movement of the vehicle in third and fourth different directions from the vehicle with respect to the surface. A processor is provided responsive to signals from the first and second optical motion detectors for computing relative movement of the vehicle over the surface.

In a first preferred arrangements of the first embodiment the first and second directions are orthogonal, and the third and fourth directions are also orthogonal to each other. The third direction may be the same as the first direction and the fourth direction may be the same as the second direction. The processor may be arranged to periodically receive signal representing absolute position of the vehicle and to compute position of the vehicle using the signals representing absolute position and the computed relative movement. The signals representing absolute position may be signals generated in response to optical markings on the surface. Where the vehicle is intended to travel along a path on the surface the optical markings may delimit transverse boundaries of the path. Alternately or in addition, optical markings may delimit longitudinal positions along the path. In another arrangement, the signals representing absolute position of the vehicle may be derived from a radio navigation device. In one arrangement, the processor is carried by a vehicle. The vehicle may alternately include a wireless data communications radio where the radio communicates signals from the first and second detectors representing movement of the vehicle to a processor located remote from the vehicle.

In accordance with a second embodiment, the invention there is provided a navigation system for a vehicle arranged to move over surface on wheels, including two wheels arranged for rotation about an axis which is fixed with respect to the vehicle. An optical motion detector is arranged on the vehicle spaced from the axis for detecting movement of the vehicle in first and second different directions from the vehicle with respect to the surface. A processor is responsive to signals from the optical motion detector for computing relative movement of the vehicle over the surface.

In the second embodiment, the first direction of the optical motion detector is preferably perpendicular to the second direction, and may be perpendicular to the axis. The processor may compute longitudinal movement of the vehicle from signals representing movement in the first direction which is perpendicular to the axis, and may compute rotation of the axis with respect to the surface from signals representing movement in the second direction. The processor may also be periodically arranged to receive signals representing absolute position of the vehicle and to compute location of the vehicle using the absolute position signals and the computed relative movement.

In accordance with the invention there is provided a first method for locating a vehicle arranged to move over a surface. The first method includes optically detecting movement of the vehicle in first and second different directions with respect to the surface from a first detector location on the vehicle. The method further includes optically detecting movement of the vehicle in third and fourth directions with respect to the surface from a second detector location on the vehicle and spaced from the first detector. The signals from the first and second detectors are processes for computing relative movement of the vehicle over the surface.

In accordance with the invention there is provided a second method for navigating a vehicle arranged to move over a surface on wheels, including two wheels arranged for rotation about a fixed axis with respect to the vehicle. Movement of the vehicle in first and second different directions is optically detected with respect to the surface from a detector located on the vehicle and is spaced from the axis. Relative movement of the vehicle is computed in a processor using signals from the optical motion detector representing movement of the vehicle in the first and second directions.

For a better understanding of the present invention, together with other and further objects, reference is made to the following description, taken in conjunction with the accompanying drawings, and its scope will be pointed out in the appended claims.

### BRIEF DESCRIPTION OF THE DRAWING

FIG. 1 is a top view of a prior art optical computer mouse.

FIG. 2 is a bottom view of the FIG. 1 mouse schematically showing the optical components thereof.

FIG. 3 is an illustration of a vehicle having an optical location system in accordance with the present invention.

FIG. 4 is a bottom view of the FIG. 3 vehicle, showing one embodiment of an optical location system according to the present invention.

FIG. 5 is a view of a surface having paths and markings thereon for use in connection with the present invention.

FIG. 6 is a bottom view of an alternate embodiment of a vehicle having an optical location system according to the present invention.

FIG. 7 is a block diagram illustrating the components of an optical location system in accordance with the present invention.

### DETAILED DESCRIPTION OF THE INVENTION

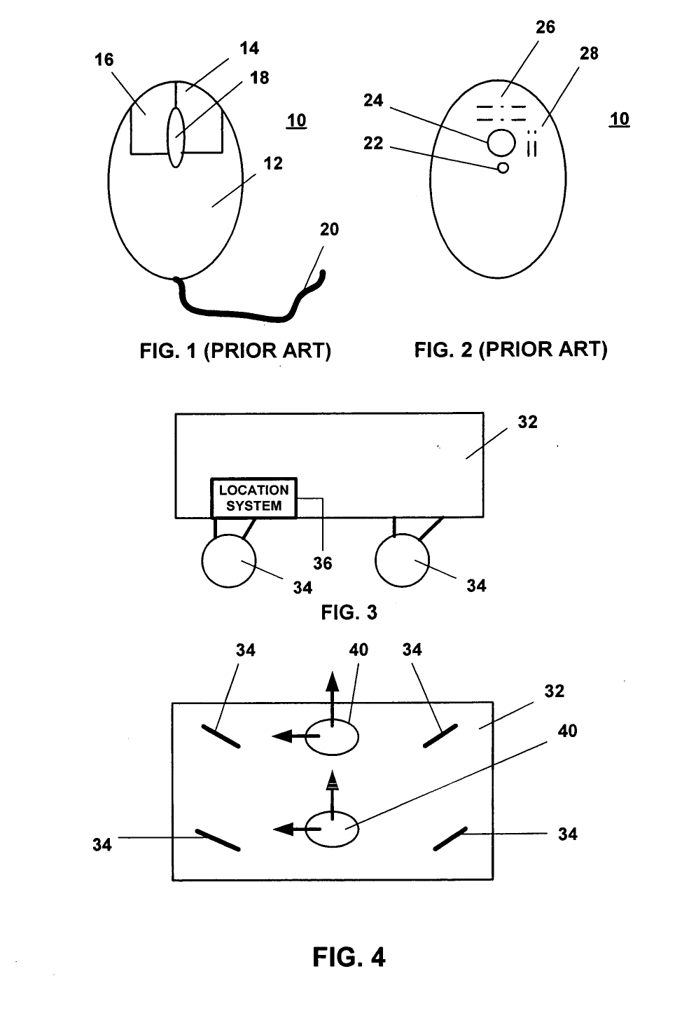

Referring to FIGS. 1 and 2 there is shown a conventional optical computer mouse of the type widely available for use in connection with the operation of personal computers and other workstation type devices. The mouse 10 shown in FIG. 1 includes operating buttons 14 and 16 and a scrolling wheel 18 all of which are located in top surface 12 of the mouse. The mouse connects conventionally to a computer system by a cord 20. FIG. 2 shows the bottom surface of the mouse, which may include slide pads, which are not shown. The bottom surface includes an illuminating device 22 such as an LED or a laser. A lens 24 is focused on the surface on which the mouse rests and forms an image of that surface on detector arrays 26 and 28. Detector arrays 26 and 28 detect movement of the mouse across the surface in a forward/reverse direction or in a cross-wise direction. As configured, the optical detection equipment of the mouse is incapable of detecting the angular orientation of the mouse, and this angular orientation is in fact irrelevant to the operation of the mouse. The mouse provides output signals respectively representing movement of the mouse in a forward and reverse direction, which is used to move the cursor on a computer screen in an up-down direction; and also representing movement of the mouse in a left or right side direction, which is used to control the movement of the cursor on a computer screen to the left or to the right.

The inventors have conceived that by rearrangement and refocusing of the optical motion detectors used in a conventional computer mouse, it is possible to detect the movement of a vehicle, such as a self-propelled cart, or a shopping cart, across a surface, such as the floor of a factory or a supermarket.

FIG. 3 shows a vehicle 30 having a vehicle body 32, wheels 34 and a vehicle locating system 36.

FIG. 4 is a representation of the underside of the vehicle 30 showing components of a first embodiment of the present invention. In the vehicle shown in FIGS. 3 and 4, the motion of the vehicle is unconstrained by the wheels. The wheels are pivotable, therefore like casters which rotate about an axis and enable the arbitrary movement of the vehicle in all directions. Thus, the vehicle can be moved from a standing position, sideways, backwards or forwards. In the case of a vehicle having unconstrained motion, the information available from an optical motion detector, of the type provided on a computer mouse, is insufficient for determining vehicle motion and hence determining the position of the vehicle. This results from the fact that a computer mouse detection system does not determine the angular orientation of the mouse with respect to the underlying surface.

The embodiment shown in a bottom view of FIG. 4, for detecting the location by “dead reckoning” by detecting movement a vehicle includes first and second optical motion detectors 40 each respectively detecting optically, the motion of the respective portion of the vehicle on which the detector is mounted in two directions with respect to a surface in which the vehicle moves. Preferably, the directions are transversed directions which are indicated by the arrows in the diagram of FIG. 4. By providing two such optical motion detectors which are spaced apart on the vehicle it becomes possible to determine a change in the angular orientation of the vehicle, by detecting movement as detected by the two optical motion detectors. For example, if the vehicle is rotated about an axis which is arranged on the line between two optical motion detectors, one detector will register a rearward motion and the other will register a forward motion, and the combination of the signals can be used to compute the angular direction change of the vehicle.

Referring to FIG. 7 there is shown a simplified block diagram of a system for locating a vehicle or for tracking motion of the vehicle by “dead reckoning”. Two optical motion detectors 86 and 88 are spaced on the bottom of the vehicle, each for detecting motion with respect to the surface on which the vehicle rides. Processor 84 receives output signals from the optical motion detectors 86 and 88 and uses those signals to compute a change in the direction and position of the vehicle. The computer change in position may be used with respect to data reporting the location of the vehicle using a data communications radio 92 having an antenna 94. Alternately, the starting position may be determined by a position detection 96. Alternately, or in addition, the change in position of the vehicle can be used to provide control signals to a motion controller 90, for operating the motors and steering mechanism of a vehicle, for example a self-propelled vehicle.

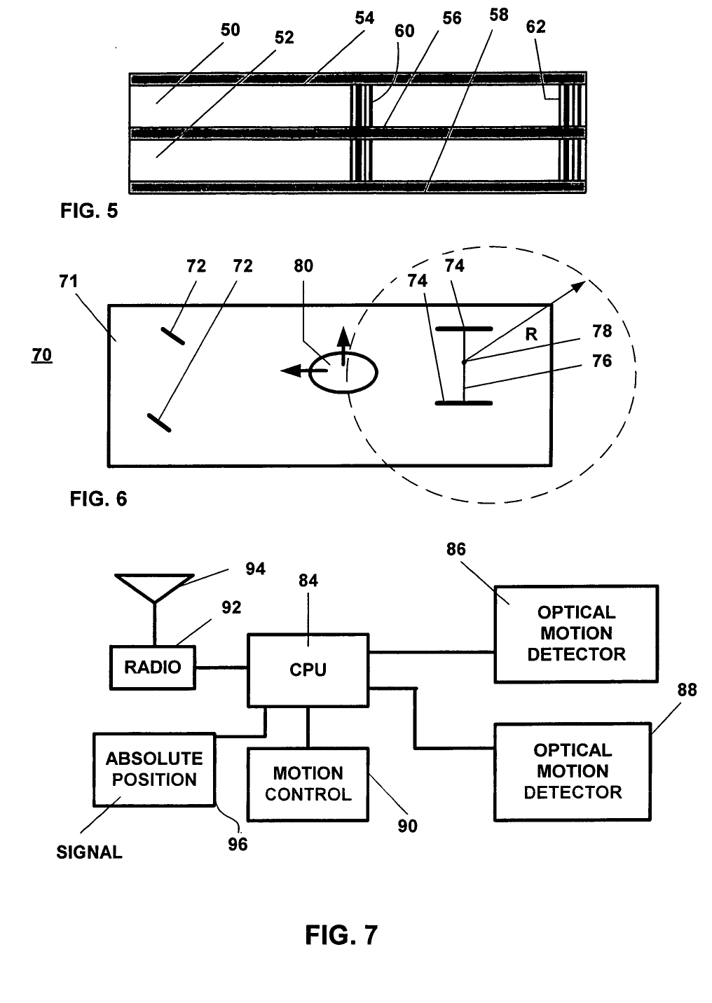

Referring to FIG. 5 there is shown a bird's eye view of first and second paths 50, 52 on a surface along which a vehicle may be arranged to travel. The edges of the paths 50, 52 are delimited by markings 54, 56 and 58, which have a contrasting reflection such that optical detectors on the vehicle, such as the optical motion detectors, can detect the fact that the vehicle has deported from the main part of the path 50 and 52 to the edge of the path 54, and a correction in the vehicle path is required. Also shown in the diagram of FIG. 5 are barcode markings 60, 62 which are arranged along the paths 50, 52. The barcode markings 60, 62 can be periodically arranged to delimit a longitudinal position, and arranged to be read by the optical motion detector acting as a barcode reader, or by a separate barcode reader, for purposes of determining the location of a vehicle longitudinally along the path 50 or 52. Accordingly, when a vehicle passes is over a marking 60, 62 its positioned along the path is known, and thereafter by using the optical motion detectors the position of the vehicle can be determined by “dead reckoning” calculation.

Other techniques may be used to get a fixed position from which “dead reckoning” navigation can be used. For example, the location of the vehicle can be determined by radio navigation, either within the vehicle or by relaying data to the vehicle using data communications radio 92. Alternately the vehicle can carry an RFID reader which reads an RFD ID tag along the path of the vehicle which provides it with a location at the time it comes within range of the RFD tag. Still further alternate arrangement is to provide an RFID tag on the vehicle itself, which is read by an RFID tag interrogator in a predetermined location, as the vehicle passes. The fact of passing a specific location can thereupon be relayed to the vehicle through the data communications radio 92.

Referring to FIG. 6 there is shown an alternate arrangement for an optical vehicle locating system according to the invention. FIG. 6 shows the bottom of a vehicle which includes a pair of steerable wheels 72 mounted to vehicle chassey 71. A second pair of fixed wheel 74 is arranged for rotation about an axis 76 which is fixed with respect to the vehicle. Accordingly, directional changes of the vehicle are, as a practice matter, constrained to rotation about a vertical are axis 78 which is at the center of axis 76 and perpendicular thereto. A single optical motion detector pair 80, which is arranged at a position spaced by a distance from the axis 76 can be used to detect motion of the vehicle in the forward or reverse direction and changes in direction of the vehicle by detection of motion by the optical motion detector in the transversed direction. Using these two variables, a data processor 84 can determine changes in position of the vehicle.

While there have been described what are believed to be the preferred embodiments of the present invention, those skilled in the art will recognize that other and further changes may be made thereto without departing from the spirit of the invention, and it is intended to claim all such changes and embodiments as fall within the true scope of the invention.

1. A location system for a vehicle arranged to move over a surface, comprising:
a first optical motion detector for detecting movement of said vehicle in first and second different directions from said vehicle with respect to said surface;
a second optical motion detector spaced on said vehicle from said first optical motion detector for detecting movement of said vehicle in third and fourth different directions from said vehicle with respect to said surface; and
a processor, responsive to signals from said first and second optical motion detectors for computing relative movement of said vehicle over said surface,
wherein at least one of said first or said second optical motion detectors is configured to read optical markings on said surface.

2. A system as specified in claim 1 wherein said first and second directions are orthogonal, and wherein said third and fourth directions are orthogonal.

3. A system as specified in claim 2 wherein said third direction is the same as said first direction, and wherein said fourth direction is the same as said second direction.

4. A system as specified in claim 1 wherein said processor is further arranged to periodically receive signals representing absolute position of said vehicle, and wherein said processor is arranged to compute position of said vehicle using said signals representing absolute position and said computed relative movement.

5. A system as specified in claim 4 wherein said signals representing absolute position are signals generated in response to said optical markings on said surface.

6. A system as specified in claim 5 wherein said surface includes a path for travel of said vehicle, and wherein said optical markings delimit transverse boundaries of said path.

7. A system as specified in claim 5 wherein said surface includes a path for travel of said vehicle, and wherein said optical markings delimit longitudinal positions along said path.

8. A system as specified in claim 4 wherein said signals representing absolute position of said vehicle are derived from a radio navigation device.

9. A system as specified in claim 1 wherein said processor is carried by said vehicle.

10. A system as specified in claim 1 wherein said vehicle includes a wireless data communications radio, and wherein said radio communicates signals from said first and second detectors representing movement of said vehicle to a processor located remote from said vehicle.

11. A navigation system for a vehicle arranged to move over a surface on wheels, including two wheels arranged for rotation about an axis fixed with respect to said vehicle, comprising:
a optical motion detector arranged on said vehicle and spaced from said axis for detecting movement of said vehicle in first and second different directions from said vehicle with respect to said surface; and
a processor, responsive to signals from said optical motion detector for computing relative movement of said vehicle over said surface,
wherein said surface bears one or more optical markings.

12. A system as specified in claim 11 wherein said optical markings comprise bar codes.

13. A system as specified in claim 11 wherein said first direction is perpendicular to said second direction.

14. A system as specified in claim 13 wherein said first direction is perpendicular to said axis and wherein said second direction is parallel to said axis.

15. A system as specified in claim 14 wherein said processor computes longitudinal movement of said vehicle from signals representing movement in said first direction and computes rotation about said axis with respect to said surface from signals representing movement in said second direction.

16. A system as specified in claim 13 wherein said processor is further arranged to periodically receive signals representing absolute position of said vehicle, and wherein said processor is arranged to compute position of said vehicle using said signals representing absolute position and said computed relative movement.

17. A system as specified in claim 16 wherein said signals representing absolute position are signals generated in response to said optical markings on said surface.

18. A system as specified in claim 17 wherein said surface includes a path for travel of said vehicle, and wherein said optical markings delimit transverse boundaries of said path.

19. A system as specified in claim 17 wherein said surface includes a path for travel of said vehicle, and wherein said optical markings delimit longitudinal positions along said path.

20. A system as specified in claim 16 wherein said signals representing absolute position of said vehicle are derived from a radio navigation device.

21. A system as specified in claim 12 wherein said processor is carried by said vehicle.

22. A system as specified in claim 12 wherein said vehicle includes a wireless data communications radio, and wherein said radio communicates signals from said first and second detectors representing movement of said vehicle to a processor located remote from said vehicle.

23. A method for locating a vehicle arranged to move over a surface, comprising:
optically detecting movement of said vehicle in first and second different directions with respect to said surface from a first detector location on said vehicle;
optically detecting movement of said vehicle in third and fourth different directions with respect to said surface from a second detector location on said vehicle remote from said first detector;
processing signals from said first and second optical motion detectors for computing relative movement of said vehicle over said surface;
reading coded data from optical markings on said surface.

24. A method as specified in claim 23 wherein said first and second directions are orthogonal, and wherein said third and fourth directions are orthogonal.

25. A method as specified in claim 24 wherein said third direction is the same as said first direction, and wherein said fourth direction is the same as said second direction.

26. A method as specified in claim 23 further comprising providing signals representing absolute position of said vehicle to said processor, and computing position of said vehicle using said signals representing absolute position and said computed relative movement.

27. A method as specified in claim 26 wherein said signals representing absolute position are signals generated in response to said optical markings on said surface.

28. A method as specified in claim 27 wherein said surface include a path for travel of said vehicle, and wherein said optical markings delimit transverse boundaries of said path.

29. A method as specified in claim 28 wherein said surface includes a path for travel of said vehicle, and wherein said optical markings delimit longitudinal positions along said path.

30. A method as specified in claim 26 wherein said signals representing absolute position of said vehicle are derived from a radio navigation device.

31. A method as specified in claim 23 further including carrying said processor on said vehicle.

32. A method as specified in claim 23 further including communicating signals from said first and second detectors representing movement of said vehicle by radio data communication to a processor located remote from said vehicle.

33. A method for navigating a vehicle arranged to move over a surface on wheels, including two wheels arranged for rotation about an axis fixed with respect to said vehicle, comprising:
optically detecting movement of said vehicle in first and second different directions from said vehicle with respect to said surface from a detector location on said vehicle and spaced from said axis; and
computing in a processor relative movement of said vehicle over said surface using signals from said optical motion detector representing movement of said vehicle in said first and second directions.

34. A method as specified in claim 33 wherein said first direction is perpendicular to said second direction.

35. A method as specified in claim 34 wherein said first direction is perpendicular to said axis and wherein said second direction is parallel to said axis.

36. A method as specified in claim 35 wherein longitudinal movement of said vehicle is computed from signals representing movement in said first direction and rotation of said axis with respect to said surface is computed from signals representing movement in said second direction.

37. A method as specified in claim 33 further comprising providing signals representing absolute position of said vehicle to said processor, and computing position of said vehicle using said signals representing absolute position and said computed relative movement.

38. A method as specified in claim 37 wherein said signals representing absolute position are signals generated in response to optical markings on said surface.

39. A method as specified in claim 38 wherein said surface includes a path for travel of said vehicle, and wherein said optical markings delimit transverse boundaries of said path.

40. A method as specified in claim 38 wherein said surface includes a path for travel of said vehicle, and wherein said optical markings delimit longitudinal positions along said path.

41. A method as specified in claim 37 wherein said signals representing absolute position of said vehicle are derived from a radio navigation device.

42. A method as specified in claim 33 further including carrying said processor on said vehicle.

43. A method as specified in claim 33 further including communicating signals from said first and second detectors representing movement of said vehicle by radio data communication to a processor located remote from said vehicle.
